(19) United States
(12) Patent Application Publication
(10) Pub. No.: US 2008/0056806 A1
(43) Pub. Date: Mar. 6, 2008

(54) Mechanical Pencil with Battery Operated Spinning Eraser

(76) Inventor: Christopher Crawford, Otsego, MI (US)

Correspondence Address: LITMAN LAW OFFICES, LTD., P.O. BOX 15035, CRYSTAL CITY STATION, ARLINGTON, VA, 22215, US

(21) Appl. No.: 11/684,850

(22) Filed: Mar. 12, 2007

Related U.S. Application Data
(60) Provisional application No. 60/830,408, filed on Sep. 5, 2006.

(51) Int. Cl. B43K 25/00; B43K 29/00

(52) U.S. Cl. 401/195; 401/52

(57) ABSTRACT

A writing implement comprising an electric eraser assembly consisting of a motor and an attached eraser, said motor capable of rotating said attached eraser, an integrated power source capable of providing power to said electric eraser assembly and a writing portion further comprising a tip capable of creating erasable marks when applied to a surface.

### CROSS REFERENCE TO RELATED APPLICATION

This application claims benefit to provisional application 60/830,408 filed on Jul. 12, 2006, entitled Mechanical Pencil with Battery Operated Spinning Eraser which is incorporated by referenced herein in its entirety.

### FIELD OF THE INVENTION

The present invention is specifically directed toward the field of professional drafting. The present invention is also broadly directed to any field which requires extensive use of a writing implement such as a pencil or pen.

### BACKGROUND OF THE INVENTION

Although a great deal of professional drafting is currently done using computer applications, manual drafting with traditional writing implements is still frequently performed by professional drafters. One of the most arduous tasks of drafting by hand is the act of making erasures. An erasure takes considerably more effort than the actual drafting because it often requires the user to repeatedly rub an eraser back and forth to achieve the desired effect. Rotating electric erasers provide a solution to this problem. These types of erasers are well known in the art and there are several stand-alone electric erasers that receive power through an integrated battery or electrical outlet. However, these products are inconvenient because they are often bulky and require the user to utilize two separate implements when drafting. There is a need for a writing implement with an integrated, battery-powered rotating eraser that enables the user to write and conveniently make erasures without having to switch between two separate devices.

There have been a number of patents directed to the field of mechanical and electrical writing devices. U.S. Patent Application No. 20050214057 to Kato discloses an extendable/contractible writing instrument with a simple rotating operation. The writing medium is exposed through a rotating motion, while at the same time also exposing an auxiliary tool, such as a silicon gum eraser, at the opposite end.

U.S. Patent Application No. 20040221422 to Aiguo discloses an eraser advancing mechanism for a mechanical pencil which has a pair of nested screws within a barrel. A second screw, with outwardly directed threads, extends through a conduit in a first screw that includes outwardly directed threads and a thread in the conduit meshing with the threads of the second screw. An eraser ferrule includes a thread that meshes with the outwardly directed threads of the first screw. The ferrule includes a knob serving to drive rotation of the eraser ferrule, and hence the first screw. The first screw includes a head with a profile that complements the inner profile of the barrel. Rotation of the first screw causes rotation of the barrel and serves to create a counter-rotation of the second screw, leading to axial movement of the second screw relative to the first screw.

U.S. Patent Application No. 20040148719 to Lychwick discloses an orbital remover including a body assembly and a tip drive assembly. The body assembly includes a main spring. The tip drive assembly includes a tip holder, a bearing guide having a convoluted race formed on an inner surface, a bearing spring, and at least two ball bearings. The ball bearings are housed in the tip drive assembly between the bearing spring and the bearing guide within the convoluted race formed in the body assembly, and the depression of the body assembly in a vertical movement actuates the ball bearings within the convoluted race, thereby rotating a tip received in the tip holder in an orbital movement. The main spring provides resistance for and returns the tip drive assembly to a starting position after the body assembly is vertically depressed.

U.S. Pat. No. 6,729,785 to Wijerama discloses a mechanical pencil and/or pen and method for operating a mechanical pencil and/or pen is provided. The mechanical pencil includes a barrel, a lead chamber, a first pressure actuator, an eraser chamber, and a second pressure actuator. The first pressure actuator is situated on the outer surface and is coupled to the lead chamber. The lead chamber holds the lead and pressing the first pressure actuator advances the lead chamber causing the lead to advance. The second pressure actuator is situated on the outer surface and is coupled to the eraser chamber. The eraser chamber holds the eraser and pressing the second pressure actuator advances the eraser chamber causing the eraser to advance. A pen including a barrel, a pen chamber, an eraser chamber, and an eraser pressure actuator is also provided. The barrel includes a pen-end, an eraser-end, and an outer surface. The pen chamber is situated in the pen-end and holds the pen. The eraser chamber is situated in the eraser-end and holds an eraser. The eraser pressure actuator is situated on the outer surface and is coupled to the eraser chamber. Pressing the eraser pressure actuator advances the eraser chamber causing the eraser to advance. A method for operating a mechanical pencil includes pushing a first pressure actuator to advance a lead in a lead advance direction out a pencil nozzle and pushing a second pressure actuator to advance an eraser in an eraser advance direction out an eraser nozzle. Retracting the lead is achieved by depressing the first pressure actuator and applying pressure to a tip of the lead projecting out the pencil nozzle. Retracting the eraser is achieved by depressing the second pressure actuator and applying pressure to a tip of the eraser projecting out the eraser nozzle.

U.S. Pat. No. 6,994,484 to Kageyama discloses a composite writing tool wherein when the rear shaft is rotated relative to a front shaft, a cam sleeve rotates with the rear shaft, and the relative rotation occurring between the cam sleeve and the front shaft and an intermediate shaft causes one of writing shafts guided in the axial direction by the intermediate shaft to be selectively held in a protruding position, and when a knock sleeve is knocked, the cam sleeve is knocked to advance a lead of the writing shaft protruded by the cam sleeve. The rear part of the intermediate shaft is inserted into the cam sleeve, and engaging pieces of the rear part of the intermediate shaft penetrate a through hole formed in a perpendicular engaging wall formed in a tail cap fastened to the rear end of a rear shaft, and are engaged with the through hole. The cam sleeve and the knock sleeve are linked to each other through a recess elsewhere than the through hole in the engaging wall.

U.S. Pat. No. 5,642,953 to Kobayashi discloses a multiplex writing implement including a mechanical pencil refill and ball-point pen refill which can be selectively used as desired, and is equipped with a delivering mechanism for delivering a stick-shaped article such as an eraser etc. The multiplex writing implement further includes: a front barrel for accommodating at least tip portions of these refills; a middle barrel for accommodating the remaining parts of these refills; a rear barrel which is able to rotate clockwise or counterclockwise relative to the middle barrel; and a cylindrical cam which moves integrally with the rear barrel and, in accordance with the rotational direction of the rear barrel, allows selective use of one of the refills by projecting any one of the refills from the front end of the front barrel and retracting the other refill. In this configuration, the front and middle barrels are integrally joined in such a state that each barrel is prevented from rotating and falling off relative to the other barrel.

U.S. Pat. No. 4,431,038 to Rome discloses a holder for a combined electric eraser-pencil sharpener which causes the sharpener to be actuated upon insertion of the pencil. A using draftsperson thus obtains the benefits of a separate fixed sharpener and avoids picking up and using the hand-held combined eraser-sharpener. The holding device comprises an open-ended cup structure containing a supporting spring. As the electric eraser-pencil sharpener being supported is moved under pencil insertion forces. Switch actuation means activate the sharpener by depressing the motor switch.

U.S. Pat. No. 5,105,497 to Haque discloses an improved electric eraser that prevents crumbs from scattering, confines them in a small area around the rotating eraser, and collects crumbs in a removal container simultaneously while erasing, consisting of a suction pipe to prevent crumbs from scattering, confine crumbs to a small area around the rotating eraser, and suck the crumbs; a removable container to collect the crumbs in; a baffle to deflect and force the crumbs to settle in the container; a centrifugal fan to produce suction; an enclosure for the centrifugal fan to provide an appropriate outlet area for the sucked air; an electric motor to run the centrifugal fan; a power means; and a switching means. The suction produced by the centrifugal fan forces and transports the eraser crumbs through the suction pipe to the baffle where the crumbs are deflected, lose the momentum, and are forced to settle in the removable container for final disposal.

U.S. Pat. No. 6,092,260 to Kai discloses a hand-held blower mechanism which includes an elongated housing having an inlet and outlet, and having a nozzle portion at the outlet. A motor is positioned within the housing along a central drive axis which intersects the inlet and the outlet. A centrifugal fan is positioned within the housing adjacent the inlet and is driven by the motor about the drive axis. A reservoir is removably secured to the nozzle portion with a tube in fluid communication with the outlet to facilitate spraying of fluid from the reservoir as air is blown through the outlet by the fan. Various attachments are provided.

U.S. Pat. No. 4,037,283 to Moisiuk discloses an electric stippling device which includes a housing within which is positioned an electric motor, a rotatable eraser member operably connected to the motor for rotation therewith and a stippling shaft member operably connected to an opposite end of the motor for reciprocatory movement.

U.S. Pat. No. 6,092,951 to Greene discloses an article of manufacture for causing a ball point pen cartridge and associated tip to automatically extend from its housing when an actuator switch located at the front end of the pen housing is pressed by the user's finger. The pen tip and associated cartridge automatically retract when the user releases the pen. A D.C. motor coupled to a gear reduction assembly inside the pen housing causes an attached threaded sleeve to rotate within a stationary nut within the housing thereby driving the pen assembly forward or backward depending on the polarity of the electrical supply to the motor. Limit switches within the housing cause the pen assembly to stop at the proper locations. An alternate embodiment of the design substitutes a non-moving, conductive switch that operates on skin contact instead of a moving, mechanical type actuation within a standard electrical switch.

U.S. Pat. No. 4,299,506 to Hashimoto discloses a mechanical pencil which comprises a casing having a ferrule at its tip end and having an axially extending central bore formed therein, and a lead-containing sleeve fitted into the central bore and capable of containing a plurality of leads. The mechanical pencil includes a lead guide pipe which is mounted in the ferrule and extending into the central bore. A feed roller is rotatably mounted within the central bore between the lead guide pipe and the lead-containing sleeve for feeding a lead from the sleeve into the lead guide pipe. The feed roller has a frusto-conical configuration with its axis disposed at an angle with respect to the axis of the central bore, and is peripherally provided with a helical rib, which is adapted to engage the periphery of lead. A rotation is externally imparted to the shaft of the feed roller, thereby rotating it to feed a given length of the lead forward.

U.S. Pat. No. 5,208,987 to Christen discloses a marking device which includes a hand-held housing and electrically powered means for vibrating the housing. An ink cylinder having a writing tip at its end is slidably supported within a cartridge casing, and a spring biases the cylinder outwardly on the casing. The casing is supported on the housing of the marking device.

U.S. Pat. No. 3,997,972 to Jaunarajs discloses a writing device which includes a barrel containing a battery powered motor having a shaft extending through one end of the barrel, preferably interchangeable writing tips and a connection to the shaft by a very flexible connector. The device enables production of impressions and designs on a writing surface whose character is dependent upon the flexible connection, the tip and the writing surface, and whose variety is limited only by the will of the operator. The device is useful for example as a toy or an artist's tool.

U.S. Pat. No. 3,774,255 discloses a portable electric eraser driven by a battery powered electric motor in which the motor has a driver shaft carrying an ink eraser at one end and a pencil eraser at the other end. A centrifugal fan is mounted on the shaft behind the pencil eraser and a sleeve around the fan provides suction near the pencil eraser for removing debris, with a retractable brush being on the end of the sleeve.

U.S. Pat. No. D331,778 to Christen discloses an ornamental design for a motorized pen.

U.S. Pat. No. D413,926 to Polidoro discloses an ornamental design for a mechanical pencil.

U.S. Pat. No. D511,545 to Chiaruttini discloses an ornamental design for a “writing instrument”.

U.S. Pat. No. D511,544 to Martin discloses an ornamental design for a writing instrument with a magnet.

None of the prior discloses a mechanical pencil with an integrated electric eraser. There is a need for such a device as the spinning of the eraser to reduce the amount of effort required to perform erasures.

The principal object of the present invention is to provide a writing implement with an integrated rotating electric eraser.

It is a further object of the present invention to provide a mechanical pencil or pen with an integrated rotating electric eraser where the engine is powered by a battery inside the chassis of the pencil.

It is a further object of the present invention to provide such a pen or pencil where the battery, eraser, and pencil lead are removable and replaceable.

It is a further object of the present invention to provide such a pen or pencil where the battery is rechargeable through a recharging device integrated with the pen or pencil.

### SUMMARY OF THE INVENTION

In its preferred embodiment, the invention is a writing implement comprising an electric eraser assembly consisting of a motor and an attached eraser, said motor capable of rotating said attached eraser, an integrated power source capable of providing power to said electric eraser assembly and a writing portion further comprising a tip capable of creating erasable marks when applied to a surface.

In a further embodiment, the invention is the device of the preferred embodiment wherein said integrated power source comprises an internal battery.

In yet a further embodiment, the invention is the device of prior described embodiment wherein said electric eraser assembly and writing portion are stored within one contiguous housing, said attached eraser protruding from an aperture at one end of the housing, said tip of the writing portion protruding from the opposite end.

In still yet a further embodiment, the invention is the device of the prior described embodiment wherein said internal battery is rechargeable.

In a further embodiment, the invention is the device of the prior described embodiment wherein said housing contains an external input for charging said internal battery.

In yet a further embodiment, the invention is the device of the prior described embodiment wherein said electric eraser assembly is contained within an electric eraser assembly housing, said writing portion being contained within a separate writing portion housing, said electric eraser assembly housing being attachable to said writing portion housing through threaded recesses located at the ends of both housings, said threaded recesses capable of forming a chamber to provide adequate room for a battery to be contained therein, one of said recesses containing a spring and a negative battery contact and the other of recesses containing a positive battery contact, said electric eraser assembly housing further comprising a power button capable of engaging and disengaging said electric eraser assembly.

In yet still a further embodiment, the invention is the device in the prior described embodiment wherein said writing portion comprises a pencil mechanism capable of dispensing lead when an external button on said writing portion housing is compressed.

In a preferred embodiment, the invention is a mechanical pencil comprising an electric eraser assembly consisting of a motor and an attached eraser, a writing portion, a power source capable of providing power to said electric eraser assembly, said internal power source further comprising an internal battery, said electric eraser assembly further comprising a motor, shaft, and attached eraser, said motor being capable of rotating said attached eraser via said shaft, said electric eraser assembly stored within an elongate eraser assembly housing, wherein said eraser protrudes from an aperture in one end of said housing, and the opposite end of said housing comprises a threaded recess, said writing portion further comprising a lead dispensing mechanism and a tip, said writing portion contained within a writing portion housing, said tip protruding from one end of said housing, the opposite end consisting of a threaded recess, said electric eraser assembly housing having an external button which, when compressed, is capable of turning said eraser assembly on and off, said writing portion housing having an external button which, when compressed, causes lead to protrude from said tip, said writing portion housing and eraser assembly housing attachable via said threaded recesses, said threaded recesses capable of forming a chamber where a battery may be stored, one of said threaded recesses containing a positive battery contact, the other recess containing a negative battery contact with an attached spring.

In a further embodiment, the invention is a mechanical pencil comprising an electric eraser assembly consisting of a motor and an attached eraser, said motor capable of rotating said attached eraser, an integrated power source capable of providing power to said electric eraser assembly, a writing portion comprising a storage portion for lead and a tip, said integrated power source further comprising an internal rechargeable battery, said writing portion, electric eraser assembly, and integrated power source being stored in one contiguous housing, said eraser protruding from an aperture in one end of said housing, and said tip of the writing portion protruding from the other, said housing comprising an external input plug through which said internal battery may be charged, said housing further comprising an external button which, when compressed, engages said electric eraser assembly, said housing further comprising an external button which, when compressed, causes lead to protrude from said tip of the writing portion.

In yet a further embodiment, the invention is the device of the prior described embodiment wherein said eraser is conical in shape.

In still yet a further embodiment, the invention is the device of the prior described embodiment wherein said eraser is conical in shape.

In a further embodiment, the invention is the device of the prior described embodiment wherein said eraser is conical in shape.

### BRIEF DESCRIPTION OF THE FIGURES

FIG. 1 is a perspective view of a preferred embodiment of the mechanical pencil comprising a removable battery portion. In this Figure, the interior of the electric eraser assembly and battery housing are visible.

FIG. 2 is a perspective view of the same preferred embodiment of the mechanical pencil comprising a removable battery portion.

FIG. 3 is a perspective view of an alternative embodiment of the mechanical pencil comprising a rechargeable, non-removable battery.

FIG. 4 is a perspective view of the same alternative embodiment of the mechanical pencil comprising a rechargeable, non-removable battery. The pencil is shown here with the charging input visible.

### DETAILED DESCRIPTION OF THE PRESENT INVENTION

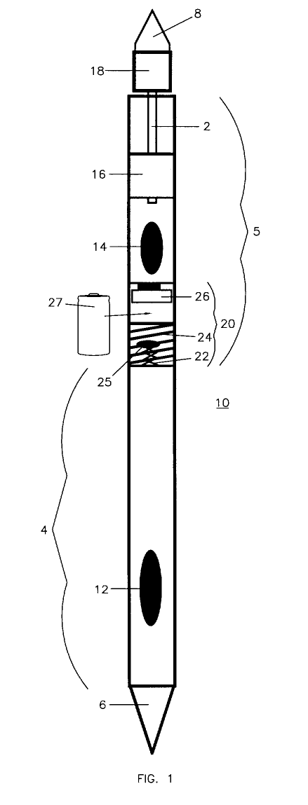

Referring to FIG. 1, a preferred embodiment of the present invention is set forth. The mechanical pencil 10 broadly consists of an eraser mechanism housing 5 and a lead housing 4. The lead housing 4 is attached to the eraser mechanism housing 5 through a series of threads 24. In a preferred embodiment, the threads 24 are external to the lead housing 4 and internal to the eraser mechanism housing 5. To use the device, a battery 27 must be inserted into the battery housing 20. The battery chamber 20 is formed by two hollow recesses at the threaded ends of the eraser mechanism housing 5 and the lead housing 4. To insert a battery, either the lead housing 4 or the eraser mechanism housing 5 may be rotated and separated. A battery may then be inserted, preferably into the recess of the lead housing 4. The eraser mechanism housing is then placed over the lead housing and screwed on to secure the battery. A spring 22 secures the battery in place. A negative contact 25 is affixed to the spring 22 which provides pressure on the battery to so that it touches the opposite positive contact 26.

Upon connection to the contacts, the battery provides power to the motor 16, which rotates an eraser 8. In the preferred embodiment, the eraser 8 is conical in shape. However, the inventor contemplates that many differently shaped erasers could be employed to achieve the same effect. The eraser 8 is secured in an eraser housing 18. The eraser 8 is removable and replaceable so that when it has been completely worn down it may be replaced in order to increase the longevity of the device. The eraser housing is attached to an elongate shaft 2 which is attached to the motor 16. When the power button 14 is pressed, this activates the motor 16, which in turn causes the shaft 2 to spin. The spinning of the shaft 2 causes the attached eraser housing 18 to spin, thus causing the eraser to spin which enables the user to perform efficient erasures. In order to stop the spinning, the user need only press the power button 14 again.

The internal functionality of the lead housing will not be described in detail as such mechanisms are well known in the art, and the mechanism is not the primary subject of the present invention. Briefly, a lead button 12 is compressed. This causes lead (not shown) to emerge through the tip 6 of the pencil. Lead is stored in a hollow area of the lead housing 4. Lead may be inserted into the housing through the tip 6 when the lead button 12 is compressed.

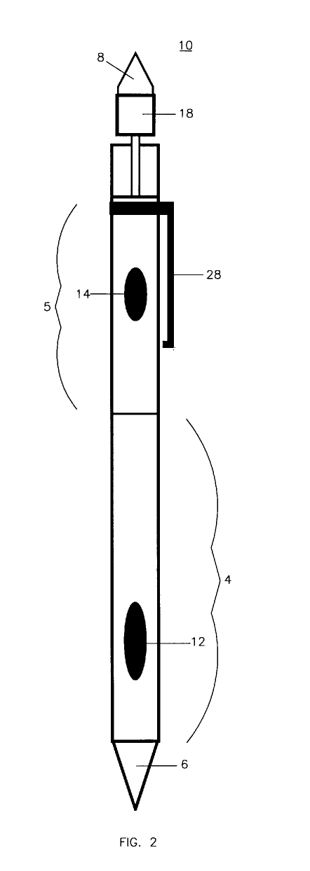

Referring to FIG. 2, the preferred embodiment of FIG. 1 is again set forth, shown here without the internal mechanisms visible. An eraser mechanism housing 5 is attached to the lead housing 4 through a series of threads 24 (See FIG. 1). The writing implement additionally incorporates an attached clip 28 to enable the user to conveniently store and carry the device.

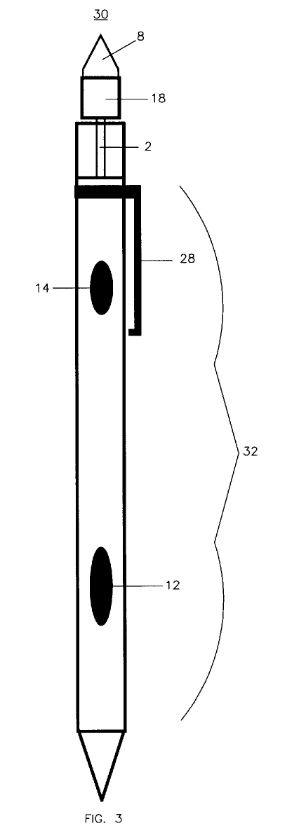

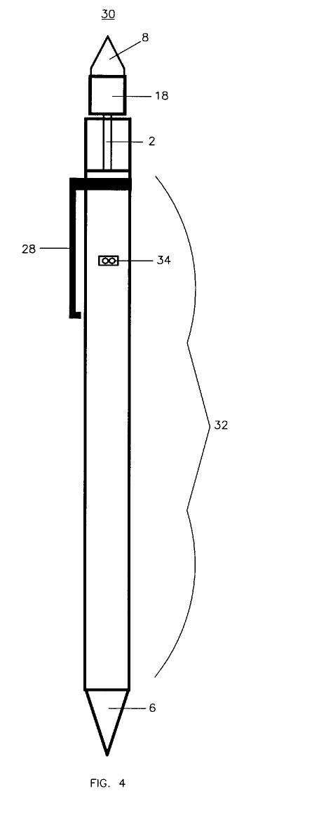

Referring to FIGS. 3 and 4, an alternative embodiment of the mechanical pencil is set forth. In this embodiment, the device consists of only one housing 32, instead of two. The device employs the same functionality as the preferred embodiment of FIG. 1. However, in the alternative embodiment the device incorporates a rechargeable, non-removable battery (not shown) which is stored internally in proximally the same location as the removable battery is stored in FIGS. 1 and 2. Additionally, the alternative embodiment incorporates a charger 34 which is connected through a power cord (not shown) to a power outlet to charge the internal battery.

While the invention has been described in detail in its preferred embodiments, it should be readily understood to one skilled in the art that the invention is not limited to the disclosed embodiments. Several alterations of the preferred embodiments shall still fall within the scope of the invention. For example, the eraser housing could also be integrated with a pen portion containing erasable ink. Additionally, the rechargeable embodiment could also incorporate a removable rechargeable battery. Accordingly, the invention is only limited by the scope of the appended claims.

I claim:

1. A writing implement comprising:
an electric eraser assembly consisting of a motor and an attached eraser, said motor capable of rotating said attached eraser;
an integrated power source capable of providing power to said electric eraser assembly; and
a writing portion further comprising a tip capable of creating erasable marks when applied to a surface.

2. The device of claim 1 wherein said integrated power source comprises an internal battery.

3. The device of claim 2 wherein said electric eraser assembly and writing portion are stored within one contiguous housing, said attached eraser protruding from an aperture at one end of the housing, said tip of the writing portion protruding from the opposite end.

4. The device of claim 3 wherein said internal battery is rechargeable.

5. The device of claim 4 wherein said housing contains an external input for charging said internal battery.

6. The device of claim 2 wherein said electric eraser assembly is contained within an electric eraser assembly housing;
said writing portion being contained within a separate writing portion housing;
said electric eraser assembly housing being attachable to said writing portion housing through threaded recesses located at the ends of both housings;
said threaded recesses capable of forming a chamber to provide adequate room for a battery to be contained therein;
one of said recesses containing a spring and a negative battery contact and the other of recesses containing a positive battery contact;
said electric eraser assembly housing further comprising a power button capable of engaging and disengaging said electric eraser assembly.

7. The device in claim 6 wherein said writing portion comprises a pencil mechanism capable of dispensing lead when an external button on said writing portion housing is compressed.

8. A mechanical pencil comprising:
an electric eraser assembly consisting of a motor and an attached eraser;
a writing portion;
a power source capable of providing power to said electric eraser assembly;
said internal power source further comprising an internal battery;
said electric eraser assembly further comprising a motor, shaft, and attached eraser, said motor being capable of rotating said attached eraser via said shaft;
said electric eraser assembly stored within an elongate eraser assembly housing, wherein said eraser protrudes from an aperture in one end of said housing, and the opposite end of said housing comprises a threaded recess;
said writing portion further comprising a lead dispensing mechanism and a tip;
said writing portion contained within a writing portion housing, said tip protruding from one end of said housing, the opposite end consisting of a threaded recess;
said electric eraser assembly housing having an external button which, when compressed, is capable of turning said eraser assembly on and off;
said writing portion housing having an external button which, when compressed, causes lead to protrude from said tip;
said writing portion housing and eraser assembly housing attachable via said threaded recesses;
said threaded recesses capable of forming a chamber where a battery may be stored;
one of said threaded recesses containing a positive battery contact, the other recess containing a negative battery contact with an attached spring.

9. A mechanical pencil comprising:
an electric eraser assembly consisting of a motor and an attached eraser, said motor capable of rotating said attached eraser;
an integrated power source capable of providing power to said electric eraser assembly;
a writing portion comprising a storage portion for lead and a tip;
said integrated power source further comprising an internal rechargeable battery;
said writing portion, electric eraser assembly, and integrated power source being stored in one contiguous housing, said eraser protruding from an aperture in one end of said housing, and said tip of the writing portion protruding from the other;
said housing comprising an external input plug through which said internal battery may be charged;
said housing further comprising an external button which, when compressed, engages said electric eraser assembly;
said housing further comprising an external button which, when compressed, causes lead to protrude from said tip of the writing portion.

10. The device in claim 1 wherein said eraser is conical in shape.

11. The device in claim 8 wherein said eraser is conical in shape.

12. The device in claim 9 wherein said eraser is conical in shape.
